(19) United States
(12) Patent Application Publication
(10) Pub. No.: US 2013/0298079 A1
(43) Pub. Date: Nov. 7, 2013

(54) APPARATUS AND METHOD FOR UNLOCKING AN ELECTRONIC DEVICE

(71) Applicant: PANTECH CO., LTD., Seoul (KR)

(72) Inventor: Hyoung-Jin KIM, Seoul (KR)

(73) Assignee: PANTECH CO., LTD., Seoul (KR)

(21) Appl. No.: 13/671,971

(22) Filed: Nov. 8, 2012

(30) Foreign Application Priority Data
May 2, 2012 (KR) 10-2012-0046574

(51) Int. Cl. G06F 3/041; G06F 3/048

(52) U.S. Cl. 715/810

(57) ABSTRACT

A method for controlling an unlocking operation includes detecting an unlocking event, displaying a virtual control mechanism for performing the unlocking operation, detecting a touch input on a touch screen of an electronic device, determining whether the touch input is an unlocking touch input, and unlocking a component of the electronic device. An electronic device includes a touch screen to receive a touch input, and to display a virtual control mechanism, and an unlocking unit to detect an unlocking event, to determine whether the touch input is an unlocking touch input, and to unlock a component of the electronic device.

### CROSS-REFERENCE TO RELATED APPLICATION(S)

This application claims priority and the benefit under 35 U.S.C. §119(a) of Korean Patent Application No. 10-2012-0046574, filed on May 2, 2012, which is hereby incorporated herein by reference for all purposes.

### BACKGROUND

1. Field

The following description relates to an apparatus and method for unlocking an electronic device.

2. Discussion of the Background

As information communication technology develops, the types of electronic devices have diversified. Many electronic devices may be equipped with touch screens as user interfaces (UIs), which may allow for interaction with users. Users may interact with such electronic devices by touching soft keys, menu bars, and/or other UI objects.

Touch screens have been employed in various portable electronic devices as UIs. Examples of a portable electronic device equipped with a touch screen include a cell phone, a smartphone, a tablet computer, a Motion Picture Experts Group Audio Layer III (MP3) player, a digital camera, a portable multimedia player (PMP), a navigation device, a handheld game console, an electronic dictionary, an electronic-book reader, a digital multimedia broadcasting (DMB) receiver, and the like.

Some electronic devices may be equipped with touch screens with a locking operation. The locking operation may refer to an operation of placing an electronic device and/or an application being executed in the electronic device in a locked state. The locking operation may prevent or reduce a likelihood of an electronic device and/or an application being executed in the electronic device from being mistakenly operated by providing an unintentional touch on the touch screen of the electronic device. For example, the locking operation may prevent an application being executed in an electronic device from being terminated, or prevent a new operation or application from being executed in response to receiving an unintentional touch on the touch screen of the electronic device.

Various unlocking methods have been suggested for use in electronic devices equipped with touch screens and/or for applications executed in such electronic devices. For example, an electronic device and/or an application being executed in the electronic device may be unlocked by pressing a predetermined set of buttons within a predetermine time period, or in a particular sequence, or by entering a password set by a user. However, these types of unlocking methods may cause some user inconvenience. Also, some users may find it difficult to set and memorize passwords.

### SUMMARY

Exemplary embodiments of the present invention provide an apparatus and method for unlocking a feature of an electronic device.

Additional features of the invention will be set forth in the description which follows, and in part will be apparent from the description, or may be learned by practice of the invention.

Exemplary embodiments of the present invention provide a method for controlling an unlocking operation including detecting an unlocking event, displaying a virtual control mechanism for performing the unlocking operation, detecting a touch input on a touch screen of an electronic device, determining whether the touch input is an unlocking touch input, and unlocking a component of the electronic device.

Exemplary embodiments of the present invention provide an electronic device including a touch screen to receive a touch input, and to display a virtual control mechanism, and an unlocking unit to detect an unlocking event, to determine whether the touch input is an unlocking touch input, and to unlock a component of the electronic device.

Exemplary embodiments of the present invention provide a method for an unlocking operation including detecting an unlocking event, displaying a virtual switch comprising a switch knob for performing an unlocking operation, detecting a touch input on a touch screen of an electronic device, determining whether the touch input corresponds to an operation of the virtual switch, and unlocking the touch screen.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a block diagram illustrating an electronic device according to an exemplary embodiment of the present invention.

FIG. 2 is a block diagram illustrating an unlocking unit of an electronic device according to an exemplary embodiment of the present invention.

FIG. 3A, FIG. 3B and FIG. 3C are diagrams illustrating a virtual control mechanism that may be displayed on the touch screen of an electronic device according to exemplary embodiments of the present invention.

FIG. 4 is a diagram illustrating an animated image of a virtual switch operation according to an exemplary embodiment of the present invention.

FIG. 5 is a diagram illustrating various positions of a virtual switch displayed on the touch screen of an electronic device during an unlocking operation of the electronic device according to an exemplary embodiment of the present invention.

FIG. 6 is a flowchart illustrating a method for unlocking an electronic device according to an exemplary embodiment of the present invention.

FIG. 7 is a flowchart a method for unlocking an electronic device according to an exemplary embodiment of the present invention.

FIG. 8 is a flowchart illustrating a method for unlocking an electronic device according to another exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

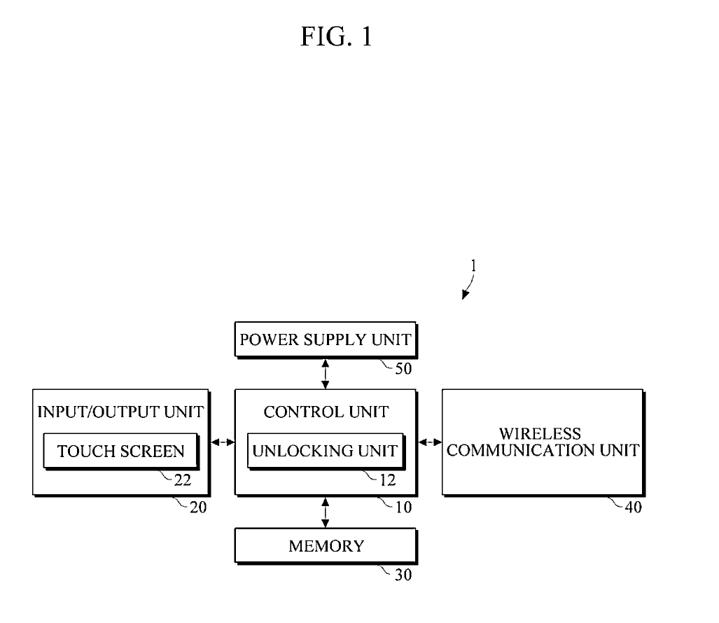

FIG. 1 illustrates an electronic device according to an exemplary embodiment of the present invention.

Referring to FIG. 1, an electronic device 1 may be a mobile device, such as, without limitation, a mobile phone, an Motion Picture Experts Group Audio Layer III (MP3) player, a digital camera, a portable multimedia player (PMP), a navigation device, a portable gaming device, an electronic dictionary, an electronic book reader, a digital multimedia broadcast receiver, a smartphone, or a tablet computer. In another example, the electronic device 1 may be a fixed device.

Referring to FIG. 1, the electronic device 1 includes a control unit 10, which includes an unlocking unit 12, an input/output unit 20, which includes a touch screen 22, a memory 30, the wireless communication unit 40, and a power supply unit 50. FIG. 1 illustrates some of the elements of the electronic device 1 that may be used to perform an unlocking operation, but is not limited thereto. According to the aspects of the invention, the electronic device 1 may additionally include other elements in addition to those illustrated in FIG. 1. The types of the additional elements of the electronic device 1 may vary based on a type of the electronic device 1 and/or an operation that may be performed by the electronic device 1. The electronic device 1 may include at least one of a sensor, such as a gravitational sensor, a proximity sensor, or an acceleration sensor, a vibration generator, a Global Positioning System (GPS) unit, a broadcast reception device, and the like. The wireless communication unit 40 may be optional in the electronic device 1.

The control unit 10 may perform general management operations, processing information, and controlling operations of the electronic device 1. For example, the control unit 10 may perform a control and signal processing operation to allow the electronic device 1 to communicate with a server or another electronic device that may be connected through a network to perform data communication. In another example, the control unit 10 may perform a control and signal processing operation to allow the electronic device 1 to execute a predetermined operation or application, such as playing a multimedia data file, executing a game application, and the like.

The control unit 10 may control the touch screen 22 of the input/output unit 20 to be unlocked in response to a predetermined condition being met. Also, the control unit 10 may control the touch screen 22 to be unlocked according to a predetermined procedure. Referring again to FIG. 1, the control unit 10 includes the unlocking unit 12, which may determine whether to unlock the touch screen 22 in response to an occurrence or execution of an unlocking event. The unlocking event may be an event that may unlock the touch screen 22, which may include without limitation at least one of pressing of a button on the electronic device 1, receiving a touch on the touch screen of the electronic device 1, passage of a predetermined period of time, receiving of a signal from an external device, and the like. Further, the unlocking event may be turned on automatically when the electronic device 1 is placed is a locked state, which may be in place until the electronic device 1 is unlocked. The unlocking unit 12 may either maintain the touch screen 22 to be in a locked or an unlocked state.

The input/output unit 20 may be provided to receive an inputted data or signals to the electronic device 1 or output data or signals processed by the electronic device 1. For example, the input/output unit 20 may include an input component, such as a camera to receive an image/video signals, a microphone to receive voice/sound data, a keypad, a dome switch, a button, a jog wheel, or a touchpad to receive data or command input. The input/output unit 20 may also include an output component, such as a display to output video signals, or a speaker to output audio signals.

The input/output unit 20 includes the touch screen 22. The touch screen 22 may be an input/output unit to allow the electronic device 1 to interact with a user. The touch screen 22 may include a touchpad combined with a display. For example, the touch screen 22 may have a structure in which a touch pad and a display may be stacked or overlapped. The touch screen 22 may also have a structure in which a touch pad and a display may be formed as a single component. A user may enter a command or information to the electronic device 1 by touching on the touch screen 22 with the user's body part (e.g., an index finger) or with a stylus pen. The electronic device 1 may output at least one of text, data, images, and moving images via the touch screen 22.

The touch screen 22 may be locked according to a control of the control unit 10, and/or may be unlocked in response to a predetermined condition being met. In response to the occurrence of an unlocking event when the touch screen 22 is in a locked state, a virtual control mechanism with a predetermined appearance that may be associated with an unlocking operation of the touch screen 22, for example, an image of a virtual switch, may be displayed on the touch screen 22. More specifically, the unlocking operation of the touch 22 may be executed by turning the virtual switch to an “off” state. During the unlocking operation of the touch screen 22, the displayed image may be varied and/or the brightness of the touch screen 22 may gradually increase in response to a manipulation of the displayed image (e.g., a virtual switch). However, aspects of the invention are not limited thereto, such that an image of a button, keyboard, a light bulb, and the like may be displayed to provide a virtual control mechanism to perform an unlocking operation.

The memory 30 may store computer programs that may be used to operate the electronic device 1. For example, the memory 30 may store various types of computer programs that may be used in the control unit 10 to perform a processing and control operation, such as an Operating System (OS) program, a plurality of module programs, a plurality of application programs, and the like. The memory 30 may also store various data and information, such as, mail data, text data, image data, moving image data, documents, music files, phonebook data, phone records, messages, and the like. Various types of memory may be used as the memory 30. For example, the memory 30 may include a Random Access Memory (RAM), an interior or exterior flash memory, a magnetic disc memory, Read Only Memory (ROM), and other similar memories.

The wireless communication unit 40 may transmit or receive electromagnetic waves to allow the electronic device 1 to communicate with a wireless communication network or another electronic device via a communication network. The wireless communication unit 40 may use one or more wireless communication protocols. Further, a variety of types and number of wireless communication protocols may be adopted by the wireless communication unit 40. For example, the wireless communication protocols that may be adopted by the wireless communication unit 40 may include, without limitation, a wireless communication protocol, such as Global System for Mobile Communication (GSM), Code Division Multiple Access (CDMA), Wideband CDMA (WCDMA), Time Division Multiple Access (TDMA), Long Term Evolution (LTE), or the like. Further, a near field communication protocol that may be adopted by the wireless communication unit 40 may include, without limitation, a Wireless Local Area Network (WLAN), Bluetooth®, ZigBee®, and the like.

The power supply unit 50 may supply power to the electronic device 1. For example, power may be supplied to the electronic device 1 by an external power source system and/or a battery installed in the electronic device 1.

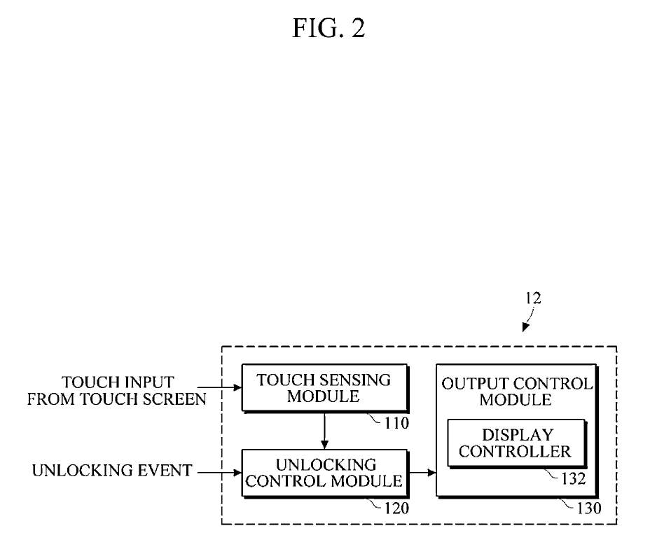

FIG. 2 illustrates an unlocking unit 12 according to an exemplary embodiment of the present invention.

Referring to FIG. 2, the unlocking unit 12 includes a touch sensing module 110, an unlocking control module 120, and an output control module 130. The elements illustrated in FIG. 2 may be displayed as modules based on their respective operations, but is not limited thereto. The elements illustrated in FIG. 2 may be incorporated into fewer modules, or new elements may be added to the unlocking unit 12.

The touch sensing module 110 may sense a touch input being received on the touch screen 22. For example, when a virtual control mechanism, such as an image of a virtual switch with a switch knob at an “off” position may be displayed on the touch screen 22 in response to the occurrence of an unlocking event, the touch sensing module 110 may sense a touch input on the touch screen 22. The touch sensing module 110 may transmit touch input information, which may be information relating to the sensed touch input, to the unlocking control module 120.

The output control module 130 may control the output of an electronic device (e.g., the electronic device 1 of FIG. 1) equipped with an unlocking unit (e.g., the unlocking unit 12 illustrated in FIG. 1) during an unlocking process. Referring again to FIG. 2, the output control module 130 includes a display controller 132, which may control the output of the display of the electronic device 1 (e.g., the touch screen 22). The display controller 132 may, without limitation, control at least one of a type, shape, pattern, color, and content of a graphic image text data that may be displayed on the touch screen. Further, the display controller 132 may also control the brightness of the background of the touch screen 22. The output control module 130 may also control various output devices other than the display of the electronic device 1, such as a sound output device, a vibration generation device, and the like. The operation of the output control module 130 may be controlled by the unlocking control module 120.

The unlocking control module 120 may perform general processing and control operations in connection with an unlocking process for an electronic device having a touch screen in a locked state.

For example, in response to the occurrence of an unlocking event, the unlocking control module 120 may initiate an unlocking process. The unlocking event may include various types of events or conditions, without limitation. For example, the receipt of a predetermined user input to unlock an electronic device (e.g., pressing of one or more buttons on the electronic device or speaking a particular voice command), or the receipt of a voice call, a video call, a Short Message Service (SMS) message, a Multimedia Message Service (MMS) message, an email, and the like, may be received as an occurrence of an unlocking event. However, aspects of the invention are not limited thereto, such that the expiration of a time limit, being outside of a particular location (i.e., a movie theater), a touch input, and the like, may also be received as an occurrence of an unlocking event.

In response to the initiation of an unlocking process or occurrence of an unlocking event, the unlocking control module 120 may display an image of a locking/unlocking control mechanism with a predetermined appearance, for example, a virtual switch with a switch knob at an “off” position, on the touch screen 22. Since a switch may be well-known mechanism that is used for turning on or off an electric device (e.g., a lamp) or an electronic device, a user may recognize or determine the displayed virtual switch image as a virtual control mechanism that may be used to control the locking/unlocking operation of the electronic device 1. Further, the user may determine that the displayed virtual switch image is associated with an operation of turning on or off the electronic device 1, a component of the electronic device 1, or a feature of the electronic device 1. According to exemplary embodiments of the present invention, an object or image that may be recognized or determined as being associated with a virtual control mechanism to control the locking or unlocking operation of the electronic device 1 may be used. However, aspects of the invention are not limited thereto, such that the object or image may be displayed along with text data, symbols, sounds, and the like.

According to exemplary embodiments of the present invention, an image of a virtual switch where its appearance may change in response to an operation of the locking or unlocking operation in the electronic device may be displayed as a virtual control mechanism. For example, a virtual button switch, which may be turned on or off by being pressed, or a virtual light switch that may be turn on or off by moving the switch knob up or down may be displayed. A change in the appearance of a virtual control mechanism may include, without limitation, at least a change in the outlines, pattern, and/or color of the object.

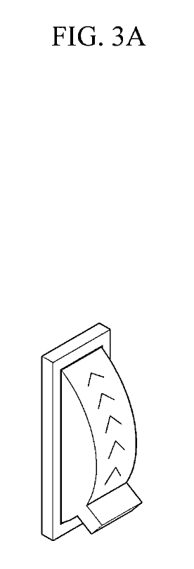

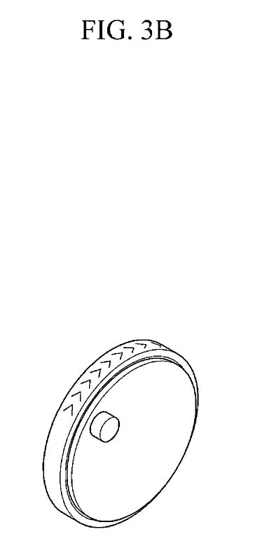

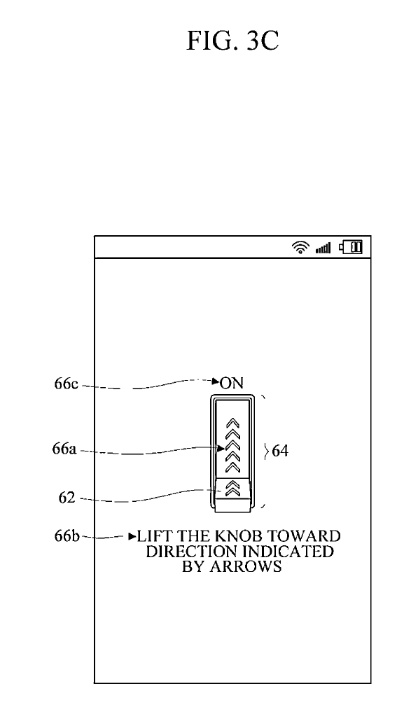

FIG. 3A, FIG. 3B, and FIG. 3C are diagrams illustrating a virtual control mechanism that may be displayed on the touch screen of an electronic device according to exemplary embodiments of the present invention. More specifically, FIG. 3A and FIG. 3B illustrate perspective views of exemplary virtual control mechanisms to provide a better depiction. However, aspects of the invention are not limited thereto, such that the virtual control mechanism may be displayed on a touch screen two-dimensionally, not three-dimensionally as illustrated in FIG. 3A and FIG. 3B.

The virtual control mechanism illustrated in FIG. 3A provides a virtual switch, similar to a light switch, and the virtual control mechanism illustrated in FIG. 3B provides a virtual rotatable wheel. The positions and/or directions of switch knobs included in the virtual control mechanisms of FIG. 3A and FIG. 3B may vary in their positions from an “on” state to an “off” state.

For example, a virtual control mechanism with a first appearance, which may have a switch knob positioned in an “off” state, may be displayed on a touch screen in response to the initiation of an unlocking process. In another example, a virtual control mechanism may be displayed on a touch screen in response to receiving an instruction designating a touch input to be used in unlocking the touch screen. An instruction may be provided in various types and displayed on one or more touch screens. More specifically, an instruction may be a text explicitly indicating a gesture to enter a touch input or a sign or image implicitly indicating a touch input to be used. However, aspects of the invention are not limited thereto, such that the instruction may be provided as a voice prompt, vibration, and the like. An instruction may be displayed on a touch screen in a static or animated manner.

FIG. 3C illustrates an example of a virtual control mechanism depicted as a virtual switch, which is displayed on the touch screen of an electronic device. Referring to FIG. 3C, the virtual control mechanism may be displayed on a touch screen along with an instruction to provide a touch input to unlock the touch screen.

In FIG. 3C, reference numeral 62 may refer to a switch knob of the virtual switch, reference numeral 66a may indicate a path of movement of the switch knob 62, and reference numerals 66b and 66c may indicate instructions relating to the switch knob 62, and the reference numeral 64 may indicate a movement path for the switch knob. More specifically, reference numeral 66b may provide text instructions for operating the virtual light switch, and reference numeral 66c may provide an indication of an “ON” state.

In the exemplary embodiments of the present invention illustrated in FIG. 3A, FIG. 3B, and FIG. 3C, an animated images of a virtual control mechanism with a switch knob of a virtual switch moving along a particular path may be displayed along the path of the movement of the switch knob.

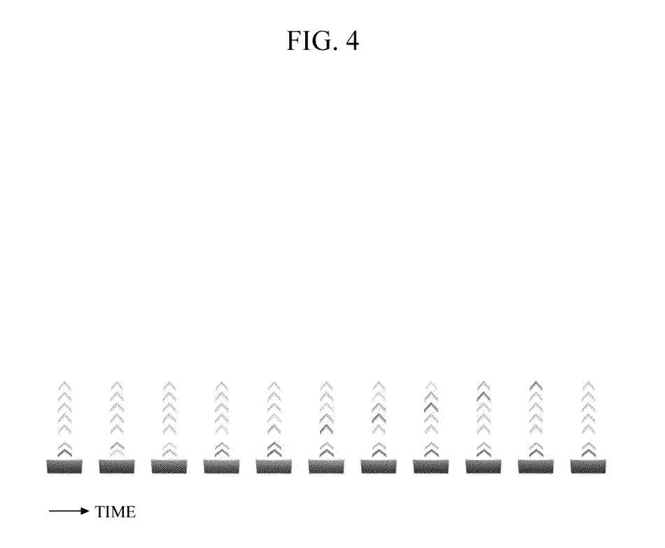

FIG. 4 is a diagram illustrating an animated image of a virtual switch operation according to an exemplary embodiment of the present invention. More specifically, FIG. 4 may illustrate a movement path of a switch knob of the virtual switch, as illustrated in FIG. 3A or FIG. 3C. Referring to FIG. 4, a user may identify a touch input to unlock a touch screen based on an instruction provided by the animated image.

Referring to back to FIG. 2, in response to the receipt of touch input from the touch sensing module 110, the unlocking control module 120 may determine whether the received touch input corresponds to a touch input for unlocking the touch screen 22, such as a touch input for moving a switch knob on a virtual control mechanism to an “off” position (see FIG. 3C). For example, a touch input that lifts or moves the switch knob of a virtual switch towards an “off” position may be recognized or determined as a touch input corresponding to a touch input for unlocking the touch screen 22. More specifically, referring to FIG. 3A, FIG. 3B, and FIG. 3C, a touch input for unlocking the touch screen 22 may correspond to lifting the switch knob of FIG. 3A or FIG. 3C to an “off” position, or turning the virtual switch wheel of FIG. 3B in a right direction, may be used as an unlocking touch input for unlocking the touch screen 22.

However, a touch input for controlling a virtual switch may not be limited to touching and dragging the switch knob of a virtual switch displayed on the touch screen 22 until the switch knob is moved to an “on” state. According to exemplary embodiments of the present invention, a switch knob, instead of an arrow that can be moved along a particular path on the touch screen 22, may be displayed as an unlocking image, and thus, various touch inputs for controlling a virtual switch may be used as unlocking touch inputs. More specifically, various directional touch gestures in operating a virtual switch to unlock the touch screen 22 may be used as an unlocking touch input.

For example, touching and flicking the switch knob of the virtual switch of FIG. 3A, FIG. 3B, or FIG. 3C such that the corresponding switch knob is moved to an “on” state may be used as an unlocking touch input. The speed at which the knob of a virtual switch displayed on the touch screen 22 moves from its “off” position to its “on” position may be uniform or may be varied over time. For example, the speed at which the switch knob of a virtual switch displayed on the touch screen 22 may move from its “off” position to its “on” position with a gradual decrease in speed and then increase, thereby providing a user with a visual effect of the switch knob being clicked during the movement from the “off” position to the “on” position.

In another example, touching the switch knob of the virtual control mechanisms of FIG. 3A, FIG. 3B, or FIG. 3C and dragging the switch knob to a particular reference position on a path of movement of the switch knob without dragging the switch knob to the end of the path of movement of the switch knob may be used as an unlocking touch input. Further, in response to the switch knob being dragged to the reference position, the switch knob may be automatically moved to its “on” position. In this manner, it may be possible to unlock the touch screen 22 while providing a user with an actual feeling of operating or turning on a virtual switch. More specifically, the user terminal may vibrate or provide an audible clicking sound in response to turning the virtual switch.

According to exemplary embodiments of the present invention, a visualization of turning on a virtual switch may be used to unlock the touch screen 22, instead of simply moving an unlocking image along a particular path, which may be indicated by an arrow. Accordingly, a touch input to control the switch knob of the virtual control mechanism displayed on the touch screen 22, as well as the touch input to control the switch knob along the path of movement may be used as an unlocking touch input. The touch input may include, without limitation, a touch and drag motion, a flicking motion, and the like.

For example, unlocking touch input information, more specifically, information relating to a touch input for moving the switch knob of the virtual switch of FIG. 3A, FIG. 3B, or FIG. 3C from its “off” position to its “on” position, may be determined and stored. In this example, the unlocking control module 120 may unlock the touch screen 22 if the touch input information provided by the touch sensing module 110 corresponds to the previously-stored unlocking touch input information. Further, the unlocking control module 120 may maintain the touch screen 22 to be in a locked state if the touch input information provided by the touch sensing module 110 does not correspond to the previously-stored unlocking touch input information.

During an unlocking process, the unlocking control module 120 may control the display controller 132 to change the appearance of the virtual switch displayed on the touch screen 22. More specifically, the display controller 132 may change the appearance of the at least the switch knob of the displayed virtual control mechanism or the appearance of the entire virtual control mechanism. For example, during an unlocking process, the position of the switch knob of the displayed virtual switch, along with at least one of the shape, color, position, and/or direction of the switch knob of the displayed virtual control mechanism may be changed. Further, the shape, pattern, color, brightness, and/or saturation of the displayed virtual switch and the path of movement of the switch knob may vary.

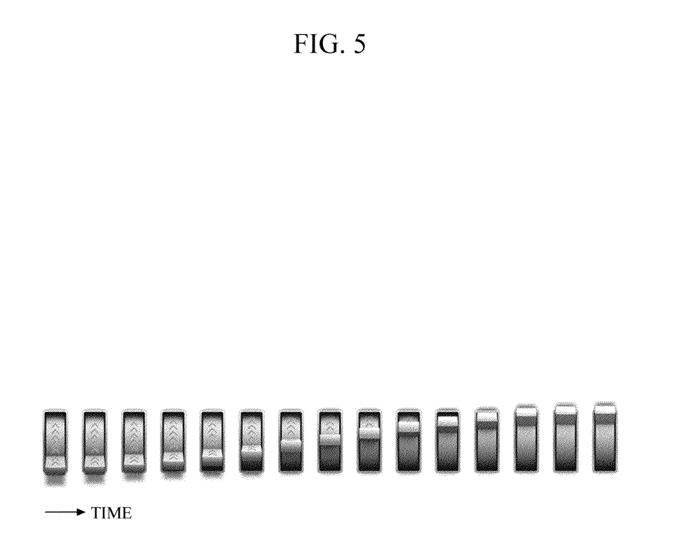

FIG. 5 is a diagram illustrating various positions of a virtual switch displayed on a touch screen of an electronic device during an unlocking operation of the electronic device according to an exemplary embodiment of the present invention.

Referring to FIG. 5, during an unlocking process, the switch knob of the virtual control mechanism of FIG. 3C gradually moves from its “off” position to its “on” position. As the switch knob of the virtual control mechanism of FIG. 3C moves from its “off” position to its “on” position, the appearance of the switch knob and the appearance of the path of the movement of the switch knob may change.

According to a related-art unlocking method, which may be characterized by simply moving an unlocking image along a particular path or from one position to another position, the position of the unlocking image may be changed during an unlocking process. However, since the appearance of the unlocking image and the path of movement of the unlocking image are not changed, a user may not be able to determine whether the unlocking process is being performed properly without keeping track of the movement of the unlocking image. On the other hand, according to exemplary embodiments of the present invention, the appearance of a virtual switch may be changed during an unlocking process. Therefore, a user can more easily and more intuitively determine whether an unlocking process is being performed and whether an unlocking touch input is being entered.

In response to a touch input (e.g., a touch and drag operation or a flicking operation) the switch knob of a virtual control mechanism displayed on the touch screen 22, the appearance of the displayed virtual switch may gradually change at regular intervals of time in accordance with the speed at which the switch knob of the displayed virtual switch may move as illustrated in FIG. 5. Further, in response to a touch input (e.g., a touch and drag operation or a flicking operation) on the switch knob along the path of the movement of the switch knob of the displayed virtual switch, instead of the switch knob of the displayed virtual switch, the appearance of the displayed virtual switch may also gradually change as illustrated in FIG. 5. More specifically, appearance of the virtual control mechanism may be modified based on or with respect to a touch input. The speed at which the knob of the displayed virtual switch moves may change based on whether the switch knob of the displayed virtual switch or the path of movement of the switch knob of the displayed virtual switch is controlled through a touch input (e.g., a touch and drag operation or a flicking operation). For example, in response to a particular point on the path of movement of the switch knob of the displayed virtual switch being touched by a user, the switch knob may move at a faster pace than normal until reaching the touched point. The switch knob may move at the same speed as in the case of touching the switch knob when a particular point on the switch knob is touched. In another example, the speed at which the switch knob of the displayed virtual switch moves may be generally be uniform, but may be higher when the path of movement of the switch knob is touched, than when the switch knob itself is touched.

The unlocking control module 120 may control the display controller 132 to gradually change, for example, the brightness of the touch screen 22 during an unlocking process. For example, the unlocking control module 120 may control the display controller 132 to gradually increase the brightness of the touch screen 22 during an unlocking process. Accordingly, a user may recognize whether an unlocking process is being performed properly based on the change in the brightness of the touch screen 22 without looking at the virtual control mechanism displayed on the touch screen 22.

Further, the unlocking control module 120 may control the output control module 130 to output, for example, a sound, a voice instruction, and/or vibration.

An unlocking process according to an exemplary embodiment will hereinafter be described.

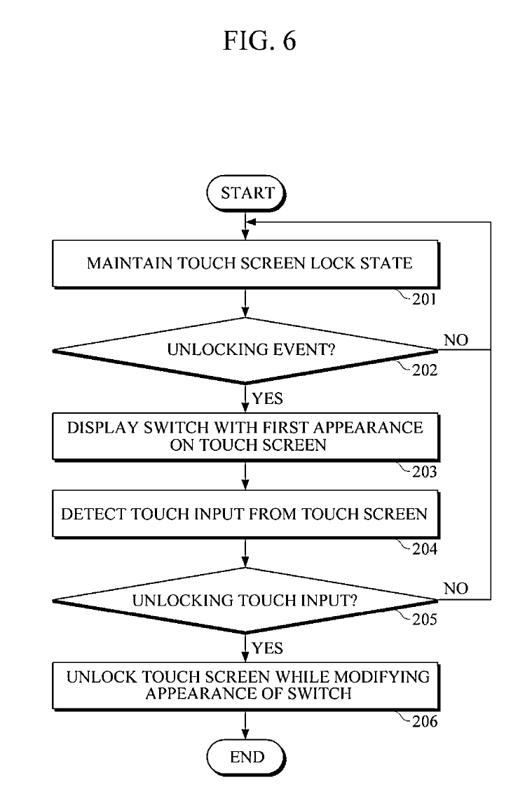

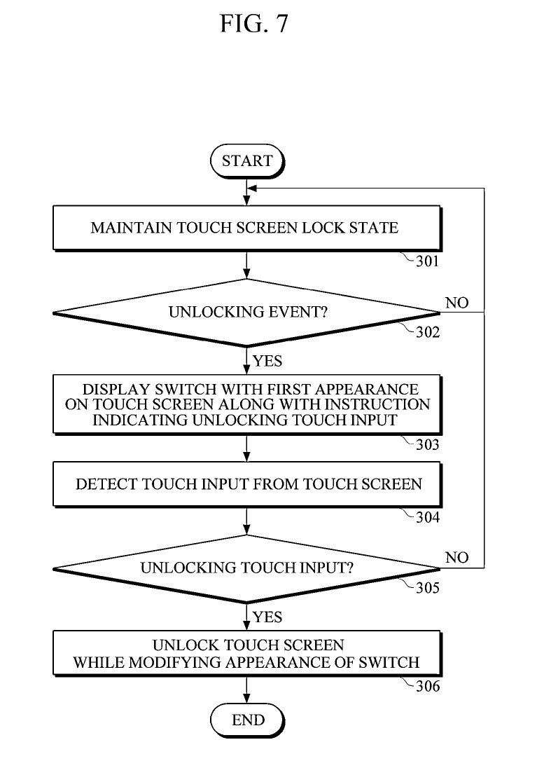

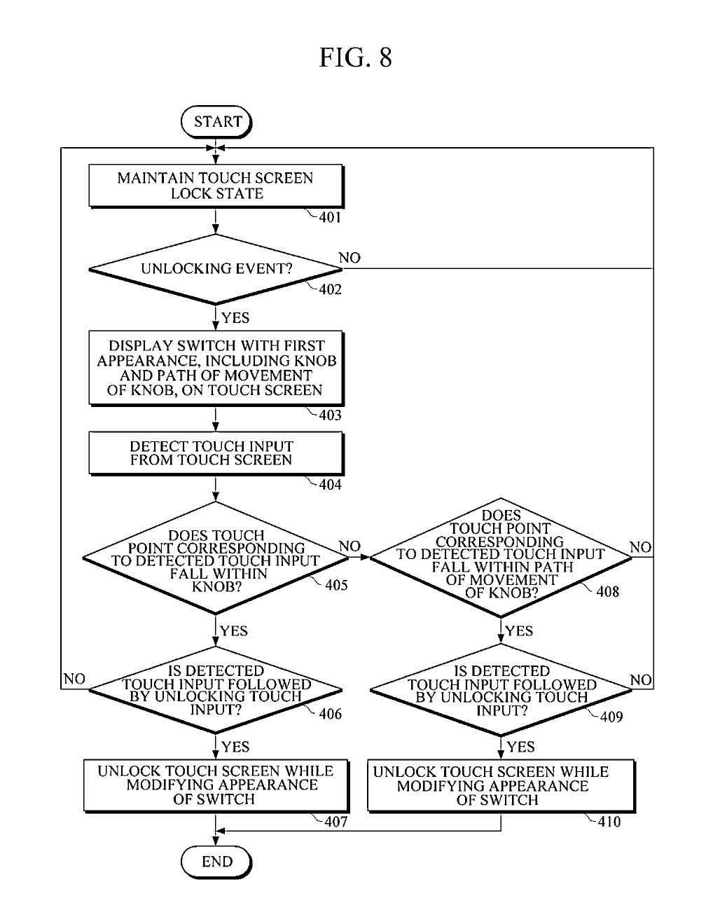

An unlocking process may be described as being performed in the electronic device 1 of FIG. 1 or the unlocking unit 12 of FIG. 1 or FIG. 2. More specifically, unless stated otherwise, the above descriptions of the electronic device 1 of FIG. 1 and the unlocking unit 12 of FIG. 1 or 2 may apply to an unlocking process, which will hereinafter be described with reference to FIG. 6, FIG. 7, and FIG. 8. However, although the methods of FIG. 6, FIG. 7, and FIG. 8 below will be described as if performed by the electronic device of FIG. 1 or the unlocking unit of FIG. 2, the methods are not limited as such.

FIG. 6 is a flowchart illustrating a method for unlocking an electronic device according to an exemplary embodiment of the present invention.

Referring to FIG. 6, in operation 201, an electronic device maintains a touch screen lock state or a locked state of the touch screen. According to exemplary embodiments of the present invention, there may be various ways in which the electronic device may enter the touch screen lock state. When the touch screen is in a locked state, the electronic device may be supplied with power, but ignores user inputs except for a specific predetermined user inputs. To reduce the likelihood of unintended use, unintentional activation or inactivation of operations, or unintentional execution or termination of applications, many electronic devices may be equipped with touch screens that support the touch screen lock state.

In operation 202, an apparatus for unlocking the electronic device, such as the unlocking control module 120 of FIG. 2, determines whether an unlocking event has occurred in the electronic device. Further, operation 202 may not be limited to determining whether the unlocking event has occurred in the electronic device, and may include monitoring in real time whether the unlocking event occurs and determining whether the unlocking control module 120 has been notified of the occurrence of the unlocking event.

In operation 202, when the unlocking event is determined to have not yet occurred or detected, the method reverts back to operation 201 where the electronic device maintains the touch screen lock state. When the unlocking event is determined to have occurred, the method proceeds to operation 203, where a virtual control mechanism (i.e., a virtual switch) to control the locking and unlocking operation of the electronic device is displayed. More specifically, in operation 203, a virtual switch with a predetermined appearance, for example, a virtual switch with a switch knob at a position corresponding to an “off” state, may be displayed on a touch screen of the electronic device. For example, in operation 203, the virtual switch illustrated in FIG. 3A or FIG. 3B may be displayed on the touch screen, but is not limited thereto. Other control mechanism that can be perceived as a tool for controlling a locking state of the electronic device may be used. Further, other control mechanisms whose appearance may differ based on its locking state (i.e., an “on” state or an “off” state) may be displayed on the touch screen. However, aspects of the invention are not limited thereto, such that a sound, vibration, or other signals may be provided to notify the user of an unlocking event.

In operation 204, a touch input from a user may be detected from the touch screen. In operation 205, in response to the detection of the touch input, a determination is made as to whether the detected touch input is a touch input for operating the displayed virtual switch. More specifically, in operation 205, the electronic device may determine whether an unlocking touch input for unlocking the touch screen of the electronic device is received. For example, operations 204 and operation 205 may be performed by the touch sensing module 110 of FIG. 2, but is not limited thereto. The unlocking control module 120 may be provided with the result of determination of the presence of a touch input. As another example, operation 204 may be performed by the touch sensing module 110, and operation 205 may be performed by the unlocking control module 120. Here, the touch sensing module 110 may transmit information relating to the detected touch input to the unlocking control module 120.

In operation 205, when the detected touch input is determined to be not the unlocking touch input, the unlocking process returns to operation 201. The touch inputs corresponding to an unlocking operation, such as the unlocking touch input, may be determined in advance or predetermined. In operation 204, the detected touch input may be determined not to be the unlocking touch input if it does not correspond with the predetermined touch input that may be associated with an unlocking operation. When no touch input is detected, it may be determined that the unlocking touch input has not been detected, and the unlocking process returns to operation 201. However, aspects of the invention are not limited thereto, such that the unlocking touch input may be determined in real time based a pattern of the received touch input, a condition that may be present when the touch input was received, and the like.

In operation 205, when the detected touch input is determined to be an unlocking touch input, the method proceeds to operation 206 where the electronic device unlocks the touch screen while modifying the appearance of the displayed virtual switch. In an example, the operation 206 may be executed by the unlocking control module 120, but is not limited thereto. Further, the unlocking control module 120 may modify the appearance of a part or the whole displayed virtual switch, which may include the switch knob and a path of movement of the switch knob, gradually or in stages. For example, in operation 206, the unlocking control module 120 may increase the brightness of the touch screen gradually or in stages while modifying the appearance of the displayed virtual switch.

FIG. 7 is a flowchart illustrating a method for unlocking an electronic device according to an exemplary embodiment of the present invention.

The exemplary embodiment of FIG. 7 may be different from the exemplary embodiment of FIG. 6 in at least that, in response to initiation of an unlocking process, a virtual switch may be displayed on a touch screen along with a corresponding instruction. The instruction may indicate an unlocking touch input that may be provided for unlocking the electronic device. The exemplary embodiment of FIG. 7 will hereinafter be described, focusing mainly on differences with the exemplary embodiment of FIG. 6.

Referring to FIG. 7, in operation 301, an electronic device maintains a touch screen lock state or a locked state of the touch screen. In operation 302, an apparatus for unlocking the electronic device, such as the unlocking control module 120 of FIG. 2, determines whether an unlocking event has occurred in the electronic device. In operation 302, when the unlocking event is determined to have not yet occurred or detected, the unlocking process returns to operation 301. When the unlocking event is determined to have occurred, the method proceeds to operation 303, where a virtual control mechanism (i.e., a virtual switch) to control the locking and unlocking operation of the electronic device is displayed. More specifically, in operation 303, a virtual switch with a predetermined appearance, for example, a virtual switch with a switch knob at a position corresponding to an “off” state, may be displayed on a touch screen of the electronic device along with an instruction for providing an unlocking touch input. Various types of the instruction may be used for providing such instructions associated with an action of turning on a virtual switch. The instruction may not restricted to a still image, and may be an animated image indicating a direction of movement of the switch knob of the displayed image as illustrated in FIG. 4. However, aspects of the invention are not limited thereto, such that the instruction may be provided in a form of a sound, vibration, flashing colors, and the like.

In operation 304, a touch input from a user may be detected from the touch screen. In operation 305, in response to the detection of the touch input, a determination is made as to whether the detected touch input is a touch input for operating the displayed virtual switch. More specifically, in operation 305, the electronic device may determine whether an unlocking touch input for unlocking the touch screen of the electronic device is received. In operation 305, when the detected touch input is determined to be not the unlocking touch input, the unlocking process returns to operation 301. Further, in operation 305, when the detected touch input is determined to be an unlocking touch input, the method proceeds to operation 306 where the electronic device unlocks the touch screen while modifying the appearance of the displayed virtual switch. In an example, the operation 306 may be executed by the unlocking control module 120, but is not limited thereto.

FIG. 8 is a flowchart illustrating a method for unlocking an electronic device according to an exemplary embodiment of the present invention.

The exemplary embodiment of FIG. 8 may be different from the exemplary embodiment of FIG. 6 at least in that a virtual switch including a switch knob and a path of movement of the switch knob is displayed, and that an unlocking process may be initiated when the middle of the path of movement of the switch knob is touched by a user. The exemplary embodiment of FIG. 8 will hereinafter be described, focusing mainly on differences with the exemplary embodiment of FIG. 6.

Referring to FIG. 8, in operation 401, an electronic device maintains a touch screen lock state or a locked state of the touch screen. In operation 402, an apparatus for unlocking the electronic device, such as the unlocking control module 120 of FIG. 2, determines whether an unlocking event has occurred in the electronic device. In operation 402, when the unlocking event is determined to have not yet occurred or detected, the unlocking process returns to operation 401. When the unlocking event is determined to have occurred, the method proceeds to operation 403, where a virtual control mechanism (i.e., a virtual switch) to control the locking and unlocking a feature of the electronic device is displayed. More specifically, in operation 303, a virtual switch with a first appearance, for example, a virtual switch with a switch knob at a position corresponding to an “off” state, may be displayed on a touch screen of the electronic device. The displayed virtual switch may include a switch knob and a path of movement for the switch knob.

In operation 404, a touch input from a user may be detected from the touch screen. In operation 405, a determination is made as to whether a touch point or a position of the touch input corresponding to the detected touch input falls within the switch knob or touches the switch knob. In operation 405, when the touch point corresponding to the detected touch input is determined to fall within the switch knob, the method proceed to operation 406. In operation 406, a determination is made as to whether the detected touch input is followed by a touch input for operating the displayed virtual switch, such as an unlocking touch input for unlocking the electronic device. In operation 406, when the detected touch input is determined to be not followed by the unlocking touch input, the unlocking process returns to operation 401. In operation 406, when the detected touch input is determined to be followed by the unlocking touch input, the method proceeds to operation 407. In operation 407, the unlocking control module 120 unlocks the electronic device while modifying the appearance of the displayed virtual switch.

In operation 405, when the touch point corresponding to the detected touch input is determined to not fall within the switch knob, the method proceeds to operation 408. In operation 408, a determination is made as to whether the touch point corresponding to the detected touch input falls within a path of the movement of the switch knob. In operation 408, when the touch point corresponding to the detected touch input is determined to not fall within the path of the movement of the switch knob, the unlocking process returns to operation 401. In operation 408, when the touch point corresponding to the detected touch input is determined to fall within the path of the movement of the switch knob, the method proceeds to operation 409. In operation 409, a determination is made as to whether the detected touch input is followed by the unlocking touch input. In operation 409, when the detected touch input is determined to be not followed by the unlocking touch input, the method returns to operation 401. Further, in operation 409, when the detected touch input is determined to be followed by the unlocking touch input, the method proceeds to operation 410. In operation 410, the unlocking control module 120 unlocks the electronic device while modifying the appearance of the displayed virtual switch. For example, the switch knob of the displayed virtual switch may be configured to move at a faster pace than normal until reaching the touch point corresponding to the detected touch input, and then maintain a uniform speed until arriving at a position corresponding to an “on” state. The speed at which the switch knob of the displayed virtual switch moves in operation 410 may be faster than the speed at which the switch knob of the displayed virtual switch moves in operation 407.

Although exemplary embodiments of the present invention were disclosed with respect to unlocking a touch screen of the electronic device, aspects of the invention are not limited thereto, such that the unlocking operation may be applied to the electronic device itself, an application, an operation, an event, and the like.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for controlling an unlocking operation, comprising:
detecting an unlocking event;
displaying a virtual control mechanism for performing the unlocking operation;
detecting a touch input on a touch screen of an electronic device;
determining whether the touch input is an unlocking touch input; and
unlocking a component of the electronic device.

2. The method of claim 1, further comprising modifying an appearance of the virtual control mechanism with respect to time.

3. The method of claim 1, further comprising modifying an appearance of the virtual control mechanism with respect to the touch input.

4. The method of claim 2, where in modifying the appearance of the virtual control mechanism comprises modifying at least one of shape, pattern, outline, color, brightness, and saturation of the virtual control mechanism.

5. The method of claim 1, wherein the component of the electronic device is the touch screen.

6. The method of claim 1, wherein the virtual control mechanism is a virtual switch comprising a switch knob and a path of movement of the switch knob.

7. The method of claim 1, wherein the virtual control mechanism is displayed with an instruction for performing the unlocking operation.

8. The method of claim 6, wherein the unlocking operation is performed by touching the switch knob.

9. The method of claim 6, wherein the unlocking operation is performed by touching the path of movement of the switch knob.

10. The method of claim 6, wherein the switch knob moves faster along the path of movement of the switch knob when a touch input is detected on the path of the movement of the switch knob rather than on the switch knob.

11. The method of claim 1, wherein the determining whether the touch input is an unlocking touch input comprises determining whether the touch input corresponds with a predetermined touch input.

12. An electronic device, comprising:
a touch screen to receive a touch input, and to display a virtual control mechanism; and
an unlocking unit to detect an unlocking event, to determine whether the touch input is an unlocking touch input, and to unlock a component of the electronic device.

13. The electronic device of claim 12, wherein the unlocking unit modifies an appearance of the virtual control mechanism with respect to time.

14. The electronic device of claim 12, wherein the unlocking unit modifies an appearance of the virtual control mechanism with respect to the touch input.

15. The electronic device of claim 12, wherein the component of the electronic device is the touch screen.

16. The electronic device of claim 12, wherein the virtual control mechanism is a switch comprising a switch knob and a path of movement of the switch knob.

17. The electronic device of claim 12, wherein the virtual control mechanism is displayed with an instruction to perform the unlocking operation.

18. The electronic device of claim 17, wherein unlocking unit unlocks the component when the switch knob is touched.

19. The electronic device of claim 17, wherein unlocking unit unlocks the component when the path of movement of the switch knob is touched.

20. The electronic device of claim 17, wherein the switch knob moves faster along the path of movement of the switch knob when a touch input is detected on the path of the movement of the switch knob rather than on the switch knob.

21. The electronic device of claim 12, wherein the unlocking unit determines whether the touch input corresponds to a predetermined touch input to determine whether the touch input is the unlocking touch input.

22. A method for controlling an unlocking operation, comprising:
detecting an unlocking event;
displaying a virtual switch comprising a switch knob for performing an unlocking operation;
detecting a touch input on a touch screen of an electronic device;
determining whether the touch input corresponds to an operation of the virtual switch; and
unlocking the touch screen.
